(19) United States
(12) Patent Application Publication
(10) Pub. No.: US 2001/0043278 A1
(43) Pub. Date: Nov. 22, 2001

(54) Information input apparatus

(75) Inventor: Akihiko Hamamura, Chiba-shi (JP)

Correspondence Address: OLIFF & BERRIDGE, PLC, P.O. Box 19928, Alexandria, VA, 22320, US

(73) Assignee: Nikon Corporation

(21) Appl. No.: 09/916,675

(22) Filed: Jul. 30, 2001

Related U.S. Application Data
(63) Continuation of application No. 08/880,720, filed on Jun. 23, 1997.

(30) Foreign Application Priority Data
Jun. 25, 1996 (JP) 08-164290

(51) Int. Cl. H04N 5/222

(52) U.S. Cl. 348/333.01; 348/375; 348/239

(57) ABSTRACT

An electronic camera efficiently performs the operation of an electronic viewfinder and the inputting of line-drawings. When line-drawing input is performed, e.g., by operating a touch tablet, only the input line-drawing is displayed on a display device, e.g., a LCD without the LCD being operated as an electronic viewfinder. When operation as an electronic viewfinder is caused, for example, by pressing a release button halfway, so as to cause an image formed on an imaging device, e.g., a CCD to be displayed on the LCD, subsequent input of a line-drawing using the touch tablet is prohibited, and a line-drawing is not displayed on the LCD.

### INCORPORATION BY REFERENCE

The disclosure of the following priority application is herein incorporated by reference: Japanese Patent Application No. 08-164290 filed Jun. 25, 1996.

### BACKGROUND OF THE INVENTION

1. Field of the Invention

The present invention relates to an information input apparatus such as, for example, an electronic camera, that converts an image of an object into digital data and records that data.

2. Description of Related Art

Recently, in place of cameras using film, electronic cameras have come to be used that photograph images of objects using a photoelectric conversion device such as, for example, a CCD. The images are converted to digital data, and that data is recorded in an internal memory, a removable memory card, and the like. Images photographed using electronic cameras can be reproduced on the spot and displayed on LCD screens, for example, without undergoing development and printing as with conventional cameras.

Additionally, because electronic cameras record the photographed images as digital data, they are very compatible with personal computers, and have come to be used as an input apparatus for such personal computers. For example, electronic cameras may be used as tools for inputting image data when creating home pages for the Internet.

Such electronic cameras can include an LCD for displaying images formed on the CCD and other specified information, and a touch tablet formed of a transparent material through which line-drawing information such as characters and figures can be input. The touch tablet is overlaid on the LCD. Images displayed on the LCD can be observed through the touch tablet, and line-drawing information input by the touch tablet can be displayed on the LCD. Therefore, it becomes possible to use the LCD and overlaid touch tablet as an electronic viewfinder, and as an input apparatus for inputting line-drawing information.

There is, however, a problem in that when an image formed on the CCD is displayed on the LCD during the input of line-drawing information, the input line-drawing information may become difficult to see, which makes the input of information difficult.

There also is a problem in that, when used as an electronic viewfinder, the load on the control circuit that controls the LCD increases if line-drawing information is input and displayed by superimposing it with the CCD image data. This can make it impossible to smoothly display on the LCD the image formed on the CCD.

### SUMMARY OF THE INVENTION

An object of embodiments of the present invention is to provide a device in which the operation of inputting line-drawings and the like, and the operation as an electronic viewfinder, are performed independently of each other.

According to one aspect of the invention, an information input apparatus (e.g., an electronic camera) includes a controller that controls the apparatus such that information input by an information input device is not displayed on a display when an image of an object, converted into image signals by a photoelectric conversion device, is already being displayed on the display. The information input apparatus includes the photoelectric conversion device, the information input device, the controller and a memory that stores the image signals produced by the photoelectric conversion device and the information input through the information input device.

According to another aspect of the invention, the controller also (or alternatively) can control the display so that the light image formed on the photoelectric conversion device is not displayed on the display when the information input through the information input device is being displayed on the display.

The information input device can be a device, for example, a touch tablet, that inputs line-drawing information.

The controller also can prevent power from being supplied to the photoelectric conversion device when the information input by the information input device is being displayed on the display.

According to embodiments of the invention, the operation of inputting line-drawings and the like, and the operation as an electronic viewfinder, are performed independently of each other.

### BRIEF DESCRIPTION OF THE DRAWINGS

The invention will be described in conjunction with the following drawings in which like reference numerals designate like elements and wherein:

FIG. 1 is a perspective front view of an electronic camera according to one embodiment of the present invention;

FIG. 2 is a perspective rear view of the electronic camera of FIG. 1;

FIG. 3 shows one example of the internal configuration of the FIG. 1 electronic camera 1;

FIG. 4 is a block diagram showing an example of the internal electrical configuration of the FIG. 1 electronic camera;

FIG. 5 illustrates an example of a display screen displayed on the LCD of the FIG. 1 electronic camera; and

FIG. 6 is a flow chart explaining the operation of the FIG. 1 electronic camera.

### DETAILED DESCRIPTION OF PREFERRED EMBODIMENTS

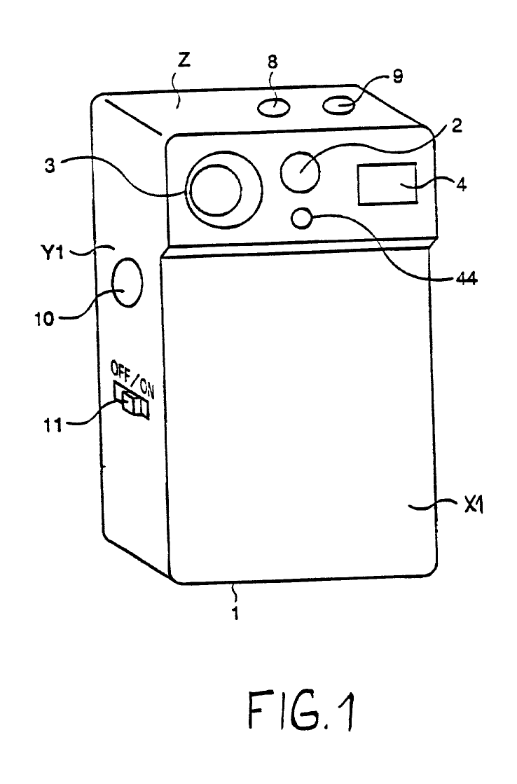

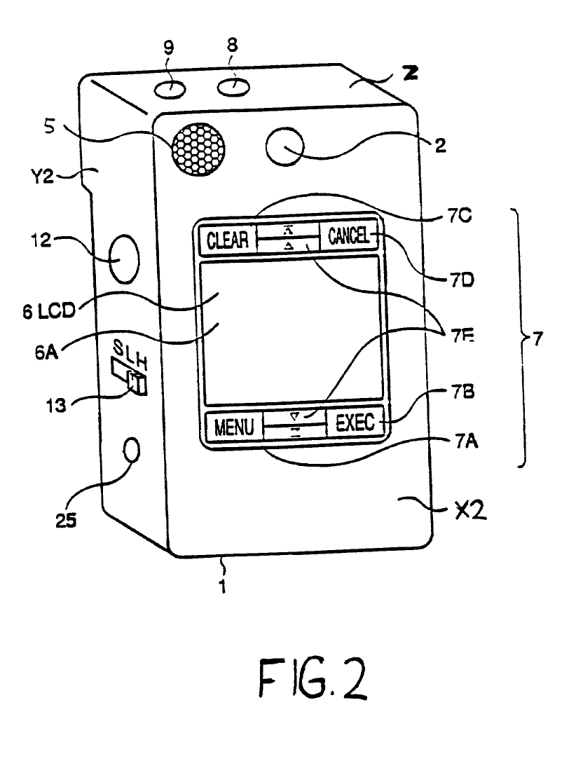

FIGS. 1 and 2 are perspective views of an electronic camera 1 according to one embodiment of the present invention. The surface of the electronic camera 1 that faces toward the object is labeled as surface X1, and the surface that faces toward the user is labeled as surface X2. A viewfinder 2, which is used to confirm the shooting scope of the object, a shooting lens 3 for acquiring a light image of the object, a strobe 4 for emitting light to illuminate the object, and a redeye reduction lamp 44 for controlling the red-eye phenomenon, are provided on the upper part of surface X1.

The above-mentioned viewfinder 2 and a speaker 5 are provided on the upper part of surface X2. Speaker 5 outputs sound corresponding to sound data recorded on a memory card, or the like, provided inside the electronic camera 1. LCD 6 and operating keys 7 also are formed on surface X2, and are positioned vertically below viewfinder 2, shooting lens 3, strobe 4 and speaker 5. On the surface of LCD 6, there is formed a so-called touch tablet 6A through which positional data corresponding to positions indicated by contact operation with a specified pen-type pointing device (simply noted below as a pen 46) can be input.

The touch tablet 6A is formed by a transparent material such as glass and/or resin so that the user can observe via touch tablet 6A an image displayed on LCD 6 formed beneath the touch tablet 6A.

Operating keys 7 include a plurality of keys corresponding to various functions as described below. Operating keys 7 are operated by the pen-type pointing device 46, for example, and are used when reproducing and displaying on LCD 6 recorded data, such as image data, sound data or text data, recorded on an internally installed memory card, or the like. For example, menu key 7A is operated when it is desired to cause menu information to be displayed on LCD 6. Execute (EXEC) key 7B is operated when it is desired to reproduce recorded data selected by the user. Clear key 7C is operated when it is desired to delete recorded data. Cancel key 7D is operated when it is desired to interrupt reproduction processing of recorded data. Scroll keys 7E are operated when it is desired to scroll the screen in a vertical direction.

A microphone 8 for collecting sound, and an earphone jack 9 for connection to an earphone (not illustrated) are provided on surface Z, which is the top surface of the electronic camera 1.

A release button (or switch) 10, which is operated when photographing an object, and a power supply switch 11 for switching the power supply ON and OFF are provided on the left side surface (surface Y1) of the camera. The release button 10 and the power supply switch 11 are positioned vertically below viewfinder 2, shooting lens 3, and strobe 4, which are provided on the upper part of surface X1.

A sound recording switch 12, which is operated when recording sound, and a continuous mode switch 13, which is operated when switching to the continuous mode during photography, are provided on surface Y2 (the right side surface) of the camera. The sound recording switch 12 and the continuous mode switch 13 are positioned vertically below viewfinder 2, shooting lens 3, and strobe 4, which are provided on the upper part of surface X1, in the same manner as in the case of the abovementioned release button 10 and power supply switch 11. Sound recording switch 12 is positioned at substantially the same height as the release button 10 on surface Y1 so that there is no feeling of incongruity when the camera 1 is held with either the left hand or the right hand.

Alternatively, the height of release button 10 and the height of sound recording switch 12 can be made different so that when only one of these switches is pressed, the switch on the opposite side surface is not accidentally pressed by a finger located on the opposite surface, which may be necessary to cancel the moment caused by pressing.

The above-mentioned continuous mode switch 13 is used when setting whether to photograph only one frame of the object or to photograph a specified plurality of frames continuously. For example, when the indicator of continuous mode switch 13 is switched to the position “S” (that is, when switched to S mode), only one frame of photography is performed when release button 10 is pressed. When the indicator of continuous mode switch 13 is switched to the position “L” (that is, when switched to L mode), photography at a rate of eight frames per second, for example, is performed while release button 10 is pressed. When the indicator of continuous mode switch 13 is switched to the position “H” (that is, when switched to H mode), photography at a rate of thirty frames per second, for example, is performed while release button 10 is pressed.

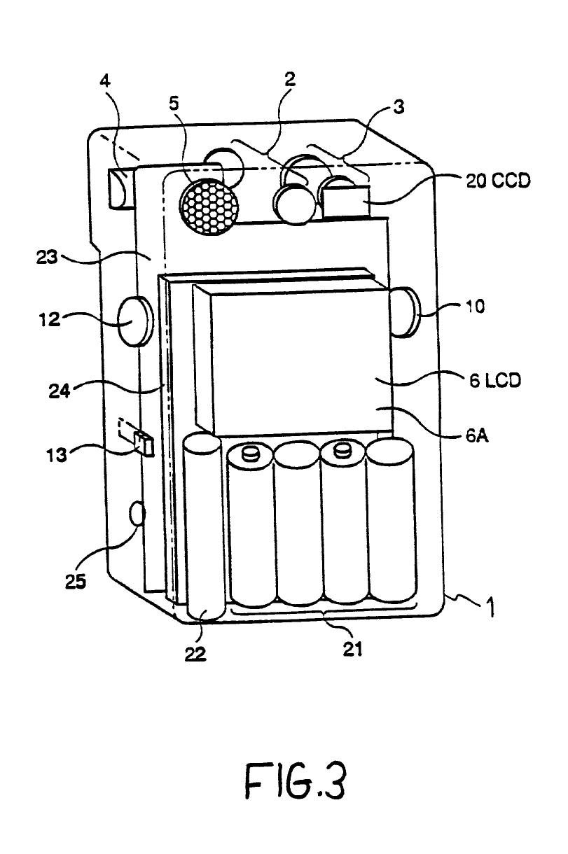

Next, the internal construction of electronic camera 1 is explained. FIG. 3 is a perspective view showing an example of the internal construction of the electronic camera shown in FIGS. 1 and 2. CCD 20 is provided at the rear part (the side adjacent to surface X2) of shooting lens 3 so as to photoelectrically convert the light image of the object, formed via shooting lens 3, to corresponding electrical signals (image signals), which are output from the CCD 20. Photoelectric conversion devices other than CCDs also can be used in the present invention.

Four cylindrical batteries (for example, AA dry cells) 21, for example, which supply electric power to each component of the camera are located below LCD 6. A condenser 22 for accumulating the charge required when strobe 4 emits light is placed alongside batteries 21.

Various types of control circuits for controlling each component of the electronic camera 1 are formed on a circuit board 23. A removable memory card (one form of recording means) 24 is provided between circuit board 23 and LCD 6 as well as batteries 21. Various types of information input into electronic camera 1 are recorded in predetermined areas of the memory card 24.

In the present embodiment, memory card 24 is removable. However, the memory may also be provided on circuit board 23 such that the various types of information can be recorded in that memory. The various types of information recorded on memory card 24 (or in the memory) can be output to an external personal computer via an input/output port 25.

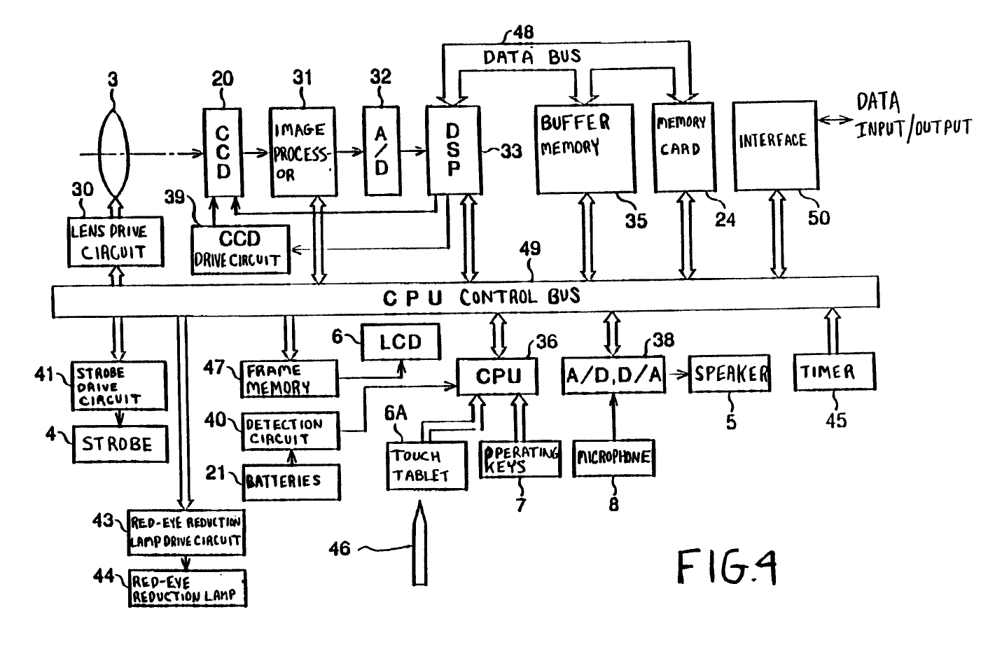

The internal electrical configuration of electronic camera 1 of the present embodiment is now explained, referring to the block diagram shown in FIG. 4. CCD 20, comprised of a plurality of pixels, photoelectrically converts to image signals (electrical signals) the light image formed on each pixel. CCD drive circuit 39 is controlled by a digital signal processor (DSP) 33, described below, so as to drive CCD 20. Lens drive circuit 30 moves shooting lens 3 in the direction along the optical axis so as to perform focusing control, and the like, for example.

Image processor 31 includes a correlated double sampling circuit (CDS) an AGC (automatic gain control circuit), and the like. CDS samples at a specified timing the image signals photoelectrically converted by CCD 20. AGC controls the gain of signals sampled by CDS. Analog/digital conversion circuit (A/D conversion circuit) 32 digitizes the image signals sampled by CDS of image-processor 31, and supplies the signals to DSP 33.

DSP 33 temporarily supplies the digitized image data to buffer memory 35 where it is stored. DSP 33 also reads the image data stored in buffer memory 35, compresses it, for example, using the JPEG (Joint Photographic Experts Group) method, and then supplies the data to memory card 24 via data bus 48, where it is recorded in a specified area (image recording area). Compression techniques other than the JPEG techniques could also be used with the invention.

CPU 36 acquires the time from a timer 45 so that information about the date and time when the subject was photographed is recorded in the image recording area of memory card 24 as header information for the image data. That is, photographic date and time data is appended to the image data in the image recording area of memory card 24.

Microphone 8 inputs sound and supplies sound signals corresponding to that sound to A/D-D/A converter 38. A/D-D/A converter 38 converts the supplied sound signals to digital sound (audio) data, and supplies the data to DSP 33. DSP 33 compresses the sound data supplied by A/D-D/A converter 38, and then supplies the data to memory card 24 so as to have it stored in a specified area (sound recording area). Also, at this time, in the sound recording area of memory card 24, data regarding the recording date and time is recorded as header information for the sound data.

Strobe drive circuit 41 is controlled by CPU 36 so as to drive strobe 4. Strobe 4 is driven by strobe drive circuit 41 so as to emit light at a specified timing for being projected onto the object.

Red-eye reduction lamp drive circuit 43 is controlled by CPU 36 so as to drive red-eye reduction lamp 44. Red-eye reduction lamp 44 is driven by red-eye reduction lamp drive circuit 43 so as to emit light at a specified timing.

When a specified position of touch tablet 6A is pressed by pen-type pointing device 46, which is operated by the user, CPU 36 reads the X-Y coordinates corresponding to the pressed position of touch tablet 6A, and accumulates that coordinate data (constituting line-drawing information) in a specified memory (not illustrated). CPU 36 also supplies the line-drawing information accumulated in memory to memory card 24 along with header information regarding the date and time the line-drawing information was input, and has that data recorded in the line-drawing information recording area of memory card 24.

Buffer memory 35 and frame memory 47 are connected to CPU 36 via CPU control bus 49. Images corresponding to image data stored in buffer memory 35 can be displayed on LCD 6 via frame memory 47. Image data that previously has undergone compression processing is supplied to buffer memory 35 via data bus 48 after it has been decompressed by DSP 33.

Speaker 5 is connected to A/D-D/A converter 38 so that sound data read from memory card 24 is output by speaker 5 after it has been decompressed by DSP 33, and is converted to analog sound signals by A/D-D/A converter 38.

Detection circuit 40 detects the value of the voltage of batteries 21, and supplies data corresponding to the detected voltage value to CPU 36.

When operating keys 7, and the various switches such as release button 10, power supply switch 11, sound recording switch 12, and continuous mode switch 13 in FIGS. 1 through 3 are operated, the corresponding signals are supplied to CPU 36. Accordingly, when operating keys 7 or the various switches are operated, CPU 36 executes the specified processing corresponding thereto.

Interface 50 performs input/output of data with external devices via input/output port 25.

The operation of the present electronic camera is now explained. First, the input/output processing of sound in the above-mentioned embodiment is explained. When the power supply switch 11 shown in FIG. 1 is switched “ON,” electric power is introduced into electronic camera 1. When the sound recording switch 12 provided on surface Y2 is pressed, the sound recording process (i.e., the input and recording of sound) is initiated. Sound input via microphone 8 is converted to digital sound (audio) data by A/D-D/A converter 38, and compression processing is applied in DSP 33. Then, the data is supplied to memory card 24 and is recorded in the sound recording area of memory card 24. At this time, in the sound recording area of memory card 24, data of the date and time of sound recording, and the like, is recorded as header information of the compressed sound data. Such operation is executed repeatedly while sound recording switch 12 is pressed. Alternatively, this sound recording process is executed repeatedly for a specified time after the sound recording switch 12 is pressed.

The PCM (Pulse Code Modulation) method or other methods can be used as a compression method for sound.

Next, the operation when photographing an object is explained. First, the case when continuous mode switch 13 provided on surface Y2 is switched to the S mode (the mode in which only one frame of photography is performed) is explained. First, power supply switch 11 provided on the side of surface Y1 is switched “ON” and electric power is introduced into electronic camera 1, as shown in FIG. 1. When release button 10 provided on surface Y1 is pressed, after confirming the object in the viewfinder 2, photographic processing of the object is initiated.

The light image of the object observed in viewfinder 2 is collected by shooting lens 3 and the image is formed on CCD 20, which includes a plurality of pixels. The light image of the object formed on CCD 20 is photoelectrically converted to image signals in each pixel and is sampled by the CDS of image processor 31. After the gain of the image signals sampled by the CDS is controlled in the AGC of image processor 31, the signals are supplied to A/D conversion circuit 32, where they are digitized. The digitized signals are then provided to DSP 33.

DSP 33 temporarily supplies the digitized image data to buffer memory 35, where it is stored. The image data stored in buffer memory 35 is compressed according to the JPEG method, for example, which includes discrete cosine transformation, quantization, and Huffman encoding. After compression, the compressed image data is supplied to memory card 24 via data bus 48. Memory card 24 records the image data supplied by DSP 33 in an image recording area. At this time, in the image recording area of memory card 24, data of the date and time of photography is recorded as header information of the above-mentioned image data.

When continuous mode switch 13 is switched to the S mode, only one frame of photography is performed each time release button 10 is pressed. Consequently, even when release button 10 is pressed and continuously held in the pressed state, only one frame of photography is performed. Additionally, when release button 10 is continuously pressed, for example, continuing for a specified amount of time, the image that was just photographed is displayed on LCD 6.

Next, the case when continuous mode switch 13 is switched to the L mode (the mode in which continuous shooting at eight frames per second is performed) is explained. First, power supply switch 11 provided on the side of surface Y1 is switched “ON” and electric power is introduced into electronic camera 1. When release button 10 provided on surface Y1 is pressed, photographic processing of the object is initiated as follows.

The light from the object observed in the viewfinder 2 is collected by shooting lens 3 and an image is formed on CCD 20. The light image of the object formed on CCD 20 is photoelectrically converted to image signals in each pixel thereof and is sampled at a rate of eight times per second by the CDS of image processor 31. At this time, the CDS also thins out, for example, the equivalent of three fourths of the pixels from CCD 20 among the electrical image signals corresponding to all the pixels.

The image signals sampled by the CDS (i.e., the image signals of one fourth of all pixels of CCD 20) are supplied to A/D conversion circuit 32, are digitized, and then are output to DSP 33.

DSP 33 temporarily supplies the digitized image data to buffer memory 35, where it is stored. Again, the image data stored in buffer memory 35 is read by DSP 33 and compressed according to the JPEG method. The compression-processed image data is supplied to memory card 24 via data bus 48, where it is stored in an image recording area. At this time, in the image recording area of memory card 24, data of the date and time of photography is recorded as header information of the above-mentioned image data.

Next, the case when continuous mode switch 13 is switched to the H mode (the mode in which continuous shooting at thirty frames per second is performed) is explained. First, power supply switch 11 provided on the side of surface Yl is switched “ON” and electric power is introduced into electronic camera 1. When release button 10 provided on surface Y1 is pressed, photographic processing of the object is initiated as follows.

The light from the object observed in viewfinder 2 is collected by shooting lens 3 and an image is formed on CCD 20. The light image of the object formed on CCD 20 is photoelectrically converted to image signals in each pixel and is sampled at a rate of thirty times per second by the CDS of image processor 31. At this time, CDS thins out, for example, the equivalent of eight ninths of the pixels from CCD 20 among the electrical image signals corresponding to all the pixels.

The image signals sampled by the CDS (i.e., the image signals of one ninth of all pixels of CCD 20) are supplied to A/D conversion circuit 32, are digitized, and then are output to DSP 33.

DSP 33 temporarily supplies the digitized image data to buffer memory 35, where it is stored. Again, DSP 33 reads the image data stored in buffer memory 35 and compresses it according to the JPEG method. The digitized and compression-processed image data is supplied to memory card 24 via data bus 48, where it is recorded in the image recording area of memory card 24 along with header information of the date and time of photography.

During photography of an object, light also can be projected on the object by causing strobe 4 to operate as needed. In that case, strobe 4 emits light at a specified timing according to control of strobe drive circuit 41. Red-eye reduction lamp 44 also can be made to emit light in order to control the red-eye phenomenon. In that case, red-eye reduction lamp 44 emits light at a specified timing according to control of red-eye reduction lamp drive circuit 43.

Next, operation when inputting two-dimensional information (pen input information (line-drawing information)) using touch tablet 6A is explained. When the pen tip of the pen-type pointing device 46 is contacted to touch tablet 6A, data corresponding to the XY coordinates of the contacted location is supplied to CPU 36. Based on the data corresponding to these XY coordinates, CPU 36 writes image data corresponding to a point, for example, having a specified size, in the position in frame memory 47 corresponding to the above-mentioned XY coordinates. By this process, a point of the specified size is displayed in a corresponding position on LCD 6.

Because touch tablet 6A is formed on the surface of LCD 6 and is formed from a transparent material, as described above, the user can observe the point displayed in the position on LCD 6 after pressing touch tablet 6A with the pen tip of the pen-type pointing device 46. This provides users with the perception that they have performed direct pen input on LCD 6. When the pen-type pointing device 46 is moved on touch tablet 6A, a line following the course of movement of pen-type pointing device 46 is displayed on the LCD 6. Furthermore, when pen-type pointing device 46 is moved intermittently on touch tablet 6A, a broken line following the movement of the pen-type pointing device is displayed on the LCD 6. Following there procedures, the user can input the desired line-drawing information such as characters and figures using touch tablet 6A and LCD 6.

When an image is displayed on LCD 6, and when line-drawing information such as characters, for example, is input by pen-type pointing device 46, the line-drawing information is formed in frame memory 47 along with the image information (i.e., from the CCD 20 output or from memory card 24) on LCD 6, and the image data and line-drawing information are displayed simultaneously.

The user can select the color of the line drawings to be displayed on LCD 6 from a plurality of colors such as black, white, red, and green, for example, by operating a color selection switch (not illustrated).

When execute (EXEC) key 7B is pressed after the input of line-drawing information by pen-type pointing device 46 and touch tablet 6A, the line-drawing information temporarily accumulated in the data area of buffer memory 35 is supplied to memory card 24 via CPU control bus 49 along with header information of the input date and time. This data is recorded in a line-drawing information recording area of memory card 24.

The line-drawing information thus recorded in memory card 24 is information having undergone compression processing. Because line-drawing information input by touch tablet 6A contains much information having a high spatial frequency component, if compression processing were to be performed by the JPEG method used to compress the above-mentioned image information, the compression rate would be poor, and the quantity of information would not become much less. Additionally, because compression by the JPEG method is irreversible compression (i.e., some of the original information is discarded during compression and therefore is not present upon decompression), it is not suitable for compression of line-drawing information, which has a relatively small quantity of information. Gathering and spreading, and the like, accompanying deficiencies in the information become prominent when the data is decompressed and displayed on LCD 6.

Therefore, line-drawing information is compressed, for example, using a run-length method such as used in facsimile machines, and the like. The run-length method is a method that compresses line-drawing information by scanning the line drawing in a horizontal direction, and encoding continuous lengths of information (points) of each color, black, white, red, green, and the like, and continuous lengths of non-information (parts not having pen input).

By using this run-length method, line-drawing information can be compressed efficiently. Additionally, when the compressed line-drawing information is decompressed, it becomes possible to suppress deficiencies in the information. Line-drawing information also can be made so that it is not compressed when the quantity of that information is comparatively small.

When an image is displayed on LCD 6, and when pen input is performed as described above, the image data and line-drawing information input by pen are formed in frame memory 47, and a composite image including the image and the line drawing is displayed on LCD 6. However, in memory card 24, the image data and the line-drawing information are recorded separately in the image recording area and the line-drawing information recording area, respectively. Thus, because the two types of information are recorded in different areas, the user can delete either image from the composite image. This also enables each type of image information to be compressed by individual compression methods and recorded.

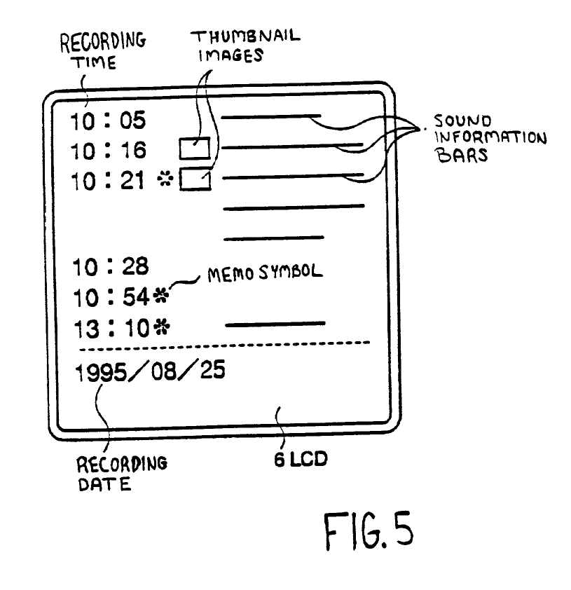

When data is recorded in at least any one of the sound recording area, the image recording area, and the line-drawing information recording area of memory card 24, a list display screen that shows a list of the recorded information can be displayed on LCD 6 as shown in FIG. 5. In the list display screen on LCD 6 shown in FIG. 5, the year, month, and day (recording date) (here, August 25, 1995) of the point in time when the information was recorded is displayed at the lower part of the screen. The recording time of the information recorded on that recording date is displayed at the leftmost side of the screen.

On the right side of the recording time, there are displayed thumbnail images when image data is recorded. These thumbnail images are reduced images created by thinning out the bit-map data of each image recorded on memory card 24. Consequently, the information having displayed thumbnail images is information that includes image information. That is, in the present example, the information recorded (input) at “10:16” and “10:21,” includes image information, while the information recorded at “10:05,” “10:28,” “10:54,” and “13:10,” does not include image information.

Memo symbol “*” represents that a specified memo is recorded as line-drawing information.

Furthermore, on the right side of the display area of the thumbnail images, there are displayed sound information bars. These bars (lines) have lengths corresponding to the lengths of the sound recording time. The sound information bars are not displayed when sound information is not input.

The user selects and specifies information to be reproduced by pressing inside a rectangular area where the desired information is displayed on the screen shown in FIG. 5 with the pen tip of pen-type pointing device 46, and reproduces the selected information by pressing the execute key 7B shown in FIG. 2 with the pen tip of the pen-type pointing device 46. By this process, the selected information is output.

For example, when the inside of the band-shaped area where “10:05” is displayed on the screen shown in FIG. 5 is pressed by the pen-type pointing device 46, CPU 36 instructs DSP 33 to reproduce the sound corresponding to the selected sound recording date and time (10:05).

According to the instruction from CPU 36, DSP 33 reads the sound data from memory card 24, applies decompression processing, and then supplies the data to A/D-D/A converter 38. A/D-D/A converter 38 converts to analog signals the decompressed sound data supplied by DSP 33 and outputs the signals from speaker 5. When an earphone (not illustrated) is connected to earphone jack 9, the sound is output from the earphone rather than from speaker 5.

When reproducing image data recorded on memory card 24, the user selects that information by pressing the desired thumbnail image with the pen tip of pen-type pointing device 46, and reproduces that selected information by pressing the execute key 78.

The image data corresponding to the selected thumbnail is read from memory card 24 by DSP 33 and is decompressed. The decompressed image data is supplied to frame memory 47 via CPU control bus 49, where it is stored as bit-map data. Next, control signals corresponding to the image data stored in frame memory 47 are supplied to LCD 6 and the corresponding image is displayed.

At this time, when sound data is also recorded (for example, in the cases of “10:16” and “10:21”), the sound can be output by speaker 5 or the earphone as described above.

The operation when LCD 6 is used as an electronic viewfinder is now explained. Release button 10 is capable of two types of operation, “pressed halfway” and “fully pressed.” When fully pressed, an image of a specified object is photographed and recorded in memory card 24 as described above. When release button 10 is pressed halfway, image signals corresponding to the light image formed on CCD 20 via the shooting lens 3 are supplied to frame memory 47 via DSP 33, and the corresponding image is displayed on LCD 6.

That is, it becomes possible to use LCD 6 as an electronic viewfinder, which can display in real time on LCD 6 an image corresponding to the light image formed on CCD 20. Consequently, the user can perform photography while viewing the image displayed on LCD 6. Because the image recorded as the photographed image can be confirmed on LCD 6, there are advantages such as being able to suppress photographic mistakes.

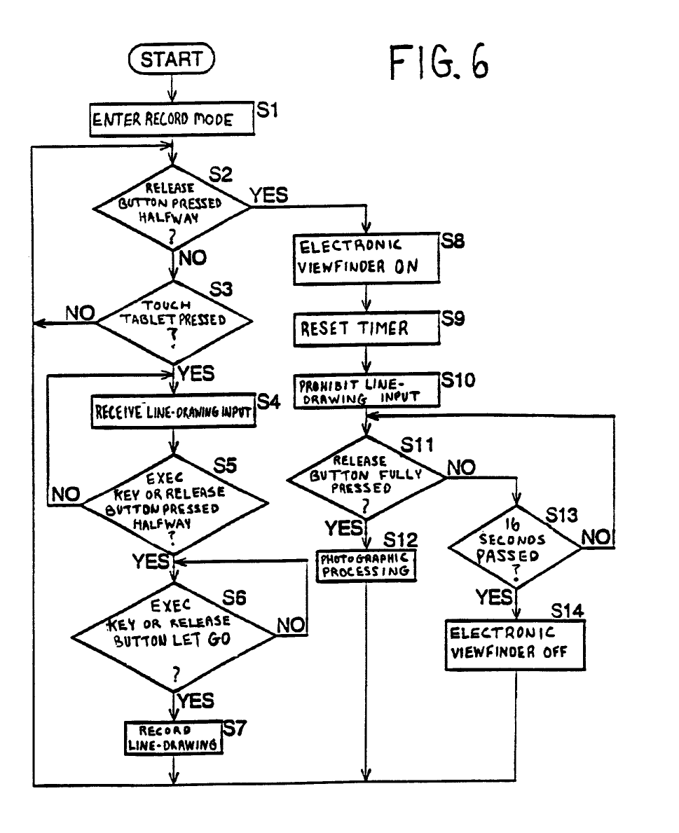

The operation in which the input of line-drawing information using LCD 6 and the use of LCD 6 as an electronic viewfinder are both performed is now explained, referring to the flowchart of FIG. 6. When power supply switch 11 of electronic camera 1 is turned ON, in step S1, the operation enters “record mode,” in which the electronic camera is capable of recording images, line-drawing information, sound, and the like, under the control of CPU 36. Other than the record mode, there are a “reproduction (play) mode,” in which the device is capable of reproducing and outputting each type of information stored in memory card 24, as well as other modes.

Next, in step S2, it is determined by CPU 36 as to whether or not release button 10 was pressed. When it is determined that release button 10 is not pressed, the operation advances to step S3, where it is determined as to whether or not touch tablet 6A was pressed. When it is determined that touch tablet 6A is not pressed, the operation returns to step S2 and processing from step S2 on down is executed iteratively.

Meanwhile, when it is determined that touch tablet 6A was pressed in step S3, the operation advances to step S4, where the receipt of line-drawing input is performed. Here, the line-drawing information input by the user, using the pen-type pointing device 46 and the touch tablet 6A, is temporarily stored and maintained in buffer memory 35, and the like. Additionally, after a specified interval of time, the operation advances to step S5, where it is determined as to whether or not execute (EXEC) key 7B or release button 10 was operated. When it is determined that neither execute key 7B nor release button 10 are operated, the operation returns to step S4, and processing from step S4 on down is executed iteratively.

During this operation, because photographic operation is not performed, supply of electric power to CCD 20, CCD drive circuit 39, and strobe drive circuit 41 is not performed. Additionally, information related to photography such as shutter speed is not displayed. This manner of operation prevents the wasteful consumption of electric power.

When it is determined that either of the execute key 7B or the release button 10 was operated in step S5, the operation advances to step S6, where it is determined as to whether or not the execute key 7B or the release button 10 has been let go. That is, when execute key 7B is pressed by pen-type pointing device 46 in step S5, it is determined in step S6 as to whether or not pen-type pointing device 46 was removed from execute key 7B, and when the user pressed release button 10 halfway with a finger, for example, it is determined in step S6 as to whether or not release button 10 returned to the original position.

When it is determined that execute key 7B or release button 10 is not let go, the operation returns to step S6, and processing from step S6 on down is executed iteratively. When it is determined that execute key 7B or release button 10 was let go, the operation advances to step S7.

In step S7, under the control of CPU 36, the line-drawing information temporarily stored in buffer memory 35 is read by DSP 33, where it undergoes compression processing, and is then supplied to memory card 24, where it is recorded. When recording of the line-drawing information ends, the operation returns to step S2, and processing from step S2 on down is executed iteratively.

In step S2, when it is determined that release button 10 was pressed halfway, the operation advances to step S8. In step S8, the image formed on CCD 20 via shooting lens 3 is displayed on LCD 6, and use as an electronic viewfinder becomes possible, as described above. That is, the electronic viewfinder is turned ON.

Next, in step S9, CPU 36 resets the value of the count of timer 45 to 0. In step S10, the input of line-drawing information by touch tablet 6A is prohibited. This is performed, for example, by preventing the CPU 36 from acquiring signals supplied by touch tablet 6A.

In step S13, it is determined as to whether or not release button 10 was fully pressed. When it is determined that release button 10 was fully pressed, the operation advances to step S12, photographic processing is performed, the photographed image is recorded in memory card 24, and the operation returns to step S2. Processing from step S2 on down is executed iteratively as detailed above.

When it is determined in step S11 that release button 10 is not fully pressed, the operation advances to step S13, and it is determined, for example, if 16 seconds (or some other predetermined time period) has passed. This determination is performed, for example, according to whether or not the value of the count of timer 45 is greater than the value of the count corresponding to 16 seconds.

When it is determined in step S13 that 16 seconds has not passed, the operation returns to step S11, and processing from step S11 on down is executed iteratively. When it is determined in step S13 that 16 seconds has passed, the operation advances to step S14, where the electronic viewfinder is turned OFF. That is, the operation to cause an image formed on CCD via shooting lens 3 to be displayed on LCD 6 is stopped, and the operation of LCD 6 as an electronic viewfinder is stopped.

After that process, the operation returns to step S2, and processing from step S2 on down is executed iteratively.

When line-drawing input is performed using LCD 6 in the manner described above, operation as an electronic viewfinder is stopped, and when LCD 6 is used as an electronic viewfinder, line-drawing input is prohibited. Consequently, when line-drawing input is performed using LCD 6, the case of line-drawing input becoming difficult to perform, due to the fact that an image formed on CCD 20 is being displayed, can be prevented.

Also, when used as an electronic viewfinder, in which an image formed on CCD 20 is displayed on LCD 6, the situation can be avoided in which line-drawing input is performed using LCD 6 and displayed overlaid on the CCD image by so-called superimposing, which can cause an excessive load to be placed on CPU 36 and DSP 33, and prevents the image formed on CCD 20 from being smoothly displayed on LCD 6.

The specific numbers used in the above-mentioned embodiment are merely one example. The invention is not limited to this one example. For example, the time period can be other than 16 seconds.

Additionally, in the above-mentioned embodiment, viewfinder 2 was made as an optical unit. Viewfinder 2 also can be a liquid crystal viewfinder using liquid crystal material or any other display.

Additionally, in the above-mentioned embodiment, only one microphone was provided. Electronic cameras also can be made such that two microphones are provided so as to record sound in stereo.

Additionally, in the above-mentioned embodiment, the various types of information were input using a pen-type pointing device. Electronic cameras also can be made such that input is performed using a finger, for example.

The display screen layout displayed on LCD 6 (see FIG. 5) is one example to which the invention is not limited. Screens having various layouts can be used. Similarly, the types and layouts of the operating keys are one example to which the invention is not limited.

According to the embodiments of the invention, because the controller controls the device such that information input by the information input means (e.g., the touch pad) is not displayed to the display means (e.g., the LCD 6) when an image that is being imaged by the imaging means (e.g., the CCD) is displayed, the operation of inputting line-drawings and the like, and the operation as an electronic viewfinder, are performed independently of each other, thereby improving operability.

Additionally, because the controller controls the device such that an image that is being imaged by the imaging means is not displayed to the display means when information that is being input by the information input means is displayed, the operation of inputting line-drawings and the like, and the operation as an electronic viewfinder, are performed independently of each other, thereby improving operability.

While this invention has been described in conjunction with specific embodiments thereof, it is evident that many alternatives, modifications and variations will be apparent to those skilled in the art. Accordingly, the preferred embodiments of the invention set forth herein are intended to be illustrative, not limiting. Various changes may be made without departing from the spirit and scope of the invention as defined in the following claims.

What is claimed is:

1. An information input apparatus comprising:
imaging means for imaging an image of a specified object to produce image signals;
information input means for enabling a user to input specified information into the information input apparatus;
storage means for storing the image signals produced by the imaging means and for storing the information input by the information input means;
display means for displaying the image imaged by the imaging means and for displaying the information input by the information input means; and
control means for controlling the apparatus such that the information input by the information input means is not displayed on the display means when the image imaged by the imaging means is being displayed on the display means.

2. The apparatus of claim 1, wherein the information input by the information input means is line-drawing information.

3. The apparatus of claim 1, further comprising:
indicating means for enabling the user to indicate that the image imaged by the imaging means is to be displayed on the display means; and wherein:
the control means prohibits the input of the information by the information input means when the indicating means indicates that the image imaged by the imaging means is to be displayed on the display means.

4. The apparatus of claim 3, wherein the information input by the information input means is line-drawing information.

5. The apparatus of claim 1, wherein the apparatus is an electronic camera that includes a lens that forms the image on the imaging means.

6. The apparatus of claim 1, wherein the storage means is removably attachable to the apparatus.

7. The apparatus of claim 1, wherein the information input means includes a touch tablet.

8. The apparatus of claim 1, wherein the control means also controls the apparatus such that the image imaged by the imaging means is not displayed on the display means when the information input by the information input means is being displayed on the display means.

9. The apparatus of claim 8, wherein the control means prevents power from being supplied to the imaging means when the information input by the information input means is being displayed on the display means.

10. An information input apparatus comprising:
imaging means for imaging an image of a specified object to produce image signals;
information input means for enabling a user to input specified information into the information input apparatus;
storage means for storing the image signals produced by the imaging means and for storing the information input by the information input means;
display means for displaying the image imaged by the imaging means and for displaying the information input by the information input means; and
control means for controlling the apparatus such that the image imaged by the imaging means is not displayed on the display means when the information input by the information input means is being displayed on the display means.

11. The apparatus of claim 10, wherein the information input by the information input means is line-drawing information.

12. The apparatus of claim 10, wherein the control means controls the apparatus such that the image imaged by the imaging means is not displayed on the display means once the input of the information by the information input means has started.

13. The apparatus of claim 12, wherein the information input by the information input means is line-drawing information.

14. The apparatus of claim 10, wherein the apparatus is an electronic camera that includes a lens that forms the image on the imaging means.

15. The apparatus of claim 10, wherein the storage means is removably attachable to the apparatus.

16. The apparatus of claim 10, wherein the information input means includes a touch tablet.

17. The apparatus of claim 10, wherein the control means prevents power from being supplied to the imaging means when the information input by the information input means is being displayed on the display means.

18. The apparatus of claim 10, wherein the control means also controls the apparatus such that the information input by the information input means is not displayed on the display means when the image imaged by the imaging means is being displayed on the display means.

19. An information input apparatus comprising:
a photoelectric conversion device that converts a light image of a specified object into image signals;
an information input device through which a user of the apparatus inputs information;
a memory, coupled to the photoelectric conversion device and to the information input device, to store the image signals of the photoelectric conversion device and the information input through the information input device;
a display, coupled to the memory, the photoelectric conversion device and to the information input device, to be capable of displaying an image of the specified object based on the image signals of the photoelectric conversion device and the information input through the information input device; and
a controller, coupled to the display, to control the display such that the display does not display the information input through the information input device when the image of the specified object is being displayed on the display.

20. The apparatus of claim 19, wherein the information input device inputs line-drawing information.

21. The apparatus of claim 19, wherein the apparatus is an electronic camera that includes a lens that forms the light image on the photoelectric conversion device.

22. The apparatus of claim 19, wherein the memory is removable from the apparatus.

23. The apparatus of claim 19, wherein the information input device includes a touch tablet.

24. The apparatus of claim 19, wherein the controller also controls the display so that the light image formed on the photoelectric conversion device is not displayed on the display when the information input through the information input device is being displayed on the display.

25. An information input apparatus comprising:
a photoelectric conversion device that converts a light image of a specified object into image signals;
an information input device through which a user of the apparatus inputs information;
a memory, coupled to the photoelectric conversion device and to the information input device, to store the image signals of the photoelectric conversion device and the information input through the information input device;
a display, coupled to the memory, the photoelectric conversion device and to the information input device, to be capable of displaying an image of the specified object based on the image signals of the photoelectric conversion device and the information input through the information input device; and
a controller, coupled to the display, to control the display so that the light image formed on the photoelectric conversion device is not displayed on the display when the information input through the information input device is being displayed on the display.

26. The apparatus of claim 25, wherein the information input device inputs line-drawing information.

27. The apparatus of claim 25, wherein the controller also controls the display so that the light image imaged formed on the photoelectric conversion device is not displayed on the display once the information input device has started to input the information.

28. The apparatus of claim 25, wherein the apparatus is an electronic camera that includes a lens that forms the image on the photoelectric conversion device.

29. The apparatus of claim 25, wherein the memory is removable from the apparatus.

30. The apparatus of claim 25, wherein the information input device includes a touch tablet.

31. The apparatus of claim 25, wherein the controller prevents power from being supplied to the photoelectric conversion device when the information input by the information input device is being displayed on the display.

32. The apparatus of claim 25, wherein the controller also controls the display such that the display does not display the information input through the information input device when the image of the specified object is being displayed on the display.

33. A method of controlling an information input apparatus having a photoelectric conversion device that converts a light image of a specified object into image signals; an information input device through which a user of the apparatus inputs information; a memory, coupled to the photoelectric conversion device and to the information input device, to store the image signals of the photoelectric conversion device and the information input through the information input device; and a display, coupled to the memory, the photoelectric conversion device and to the information input device, to be capable of displaying an image of the specified object based on the image signals of the photoelectric conversion device and the information input through the information input device; the method comprising the step of:
controlling the display such that the display does not display the information input through the information input device when the image of the specified object is being displayed on the display.

34. The method of claim 33, wherein the information input device inputs line-drawing information.

35. The method of claim 33, wherein the apparatus is an electronic camera that includes a lens that forms the light image on the photoelectric conversion device.

36. The method of claim 33, further comprising the step of:
controlling the display so that the light image formed on the photoelectric conversion device is not displayed on the display when the information input through the information input device is being displayed on the display.

37. A method of controlling an information input apparatus having a photoelectric conversion device that converts a light image of a specified object into image signals; an information input device through which a user of the apparatus inputs information; a memory, coupled to the photoelectric conversion device and to the information input device, to store the image signals of the photoelectric conversion device and the information input through the information input device; and a display, coupled to the memory, the photoelectric conversion device and to the information input device, to be capable of displaying an image of the specified object based on the image signals of the photoelectric conversion device and the information input through the information input device; the method comprising the step of:
controlling the display so that the light image formed on the photoelectric conversion device is not displayed on the display when the information input through the information input device is being displayed on the display.

38. The method of claim 37, wherein the information input device inputs line-drawing information.

39. The method of claim 37, wherein the apparatus is an electronic camera that includes a lens that forms the image on the photoelectric conversion device.

40. The method of claim 37, further comprising the step of:
preventing power from being supplied to the photoelectric conversion device when the information input by the information input device is being displayed on the display.

41. The method of claim 37, further comprising the step of:
controlling the display such that the display does not display the information input through the information input device when the image of the specified object is being displayed on the display.
